(19) United States
(12) Patent Application Publication
(10) Pub. No.: US 2015/0112694 A1
(43) Pub. Date: Apr. 23, 2015

(54) USER FRIENDLY COMPUTER ASSISTED BEHAVIORAL HEALTH ASSESSMENT SYSTEM USING PROPRIETARY ALGORITHMS TO INTERPRET AND SCORE USER GENERATED INPUT TO PRODUCE A SUBSTANTIALLY REAL-TIME PRELIMINARY EVALUATION OF A SUBJECTÂ#S BEHAVIORAL HEALTH VITAL SIGNS INCLUDING RECOMMENDATIONS FOR TREATMENT

(71) Applicants: Elizabeth Blake, Fort Lauderdale, FL (US); Hilda Besner, Fort Lauderdale, FL (US); Joel Kimmel, Fort Lauderdale, FL (US)

(72) Inventors: Elizabeth Blake, Fort Lauderdale, FL (US); Hilda Besner, Fort Lauderdale, FL (US); Joel Kimmel, Fort Lauderdale, FL (US)

(21) Appl. No.: 14/056,671

(22) Filed: Oct. 17, 2013

(51) Int. Cl. G06F 19/00

(52) U.S. Cl. CPC G06F 19/3431
USPC 705/2

(57) ABSTRACT

A user friendly computer assisted behavioral health assessment system and method of using same, wherein said behavioral health assessment uses proprietary algorithms to interpret and score user generated input to produce a substantially real-time evaluation of the subject's behavioral health including recommendations for treatment, said system includes a server connected to a communications network, a first computing device connected to the server on which software is stored for access by a third party user, at least a second computing device communicatively connected to the server via the communications network further comprising a display screen and a user interface for interactive use by the user, including access to the software stored on the first computing device to input user generated data, and software installed on the server to interpret and score user generated input to produce a substantially real-time evaluation of the subject's behavioral health including recommendations for treatment.

### STATEMENT REGARDING FEDERALLY SPONSORED RESEARCH OR DEVELOPMENT

(Not Applicable).

### THE NAMES OF THE PARTIES TO A JOINT RESEARCH AGREEMENT

(Not Applicable).

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

(Not Applicable).

### BACKGROUND OF THE INVENTION

### Field of Invention

The present invention relates to the field of behavioral health assessment systems, specifically, a user friendly computer assisted behavioral health assessment systems using proprietary algorithms to interpret and score user generated input to produce a substantially real-time preliminary evaluation of a subject's behavioral health vital signs including recommendations for treatment.

According to a 2010 report from the Substance Abuse and Mental Health Administration, one (1) in five (5) Americans experienced some sort of mental illness in 2010 and about five percent (5%) of Americans have suffered from such severe mental illness that it interfered with day-to-day school, work or family.

Based on the National Research Council and Institute of Medicine report (Preventing mental, emotional, and behavioral disorders among young people: progress and possibilities, 2009) that gathered findings from previous studies, it is estimated that thirteen to twenty percent (13%-20%) of children living in the United States (up to 1 out of 5 children) experience a mental disorder in a given year and an estimated $247 two hundred and forty seven billion dollars ($247,000,000,000.00) is spent each year on childhood mental disorders. Because of the impact on children, families, and communities, children's mental disorders are an important public health issue in the United States.

Children with serious behavioral health disorders drop-out of school, spend more time in the juvenile justice system, have high substance abuse and addiction rates, place great emotional and financial strains upon their families and society, and often end up living on the streets. Most children with behavioral health problems go undetected until a serious or fatal crisis occurs within the family, school or community environments. Research has indicated that early identification of behavioral health problems can lead to effective treatment before the problems become too big to be solved. Behavioral health interventions given at an early stage may help to significantly reduce violence, bullying, drug abuse, and other problems; but, it is critical that these problems are identified early.

The behavioral healthcare provider marketplace lacks a user friendly computer assisted behavioral health assessment system using proprietary algorithms to interpret and score user generated input to produce a substantially real-time preliminary evaluation of a subject's behavioral health vital signs including recommendations for treatment.

Previous attempts to address the need for such a behavior health assessment system have failed by at least one of the following reasons: behavior health assessment system was complicated to use, only confirmed expected diagnosis, relied on known assessment instruments, was intended to be used on a specific subsection of the population, was intended to identify a limited number of problems, was not a comprehensive evaluation tool of identified behaviors, or the system did not offer recommendations for treatment.

In order to address the void in the current marketplace for a user friendly computer assisted behavioral health assessment system using proprietary algorithms to interpret and score user generated input to produce a substantially real-time preliminary evaluation of a subject's behavioral health vital signs including recommendations for treatment, the inventors have invented the present invention, specifically, a behavior health assessment system that includes a user friendly input computing device that is communicatively connected to a network of at least one other computing device capable of executing various applications including applications that require scoring, evaluating, and saving for later retrieval, modification or further evaluation, user inputted data using proprietary algorithms to generate a substantially real-time preliminary evaluation of a subject's behavioral health vital signs including recommendations for treatment.

An objective of the present invention is to provide a user friendly computer assisted behavioral health assessment system to identify warning signs that can lead to unhealthy and potentially dangerous behaviors in children from birth through eighteen years in age.

Another objective of the present invention is to provide a user friendly computer assisted behavioral health assessment system to identify behavior health problem areas and their severity in children from birth through eighteen years in age, wherein the range of behavior health problems spans the entire range of normal to maladaptive behavioral health problems.

Another objective of the present invention is to provide a user friendly computer assisted behavioral health assessment system to provide physicians and other health providers with a graphical image indicating the user's behavioral health problem areas.

Another objective of the present invention is to provide a user friendly computer assisted behavioral health assessment system that provides substantially real-time treatment recommendations based on the information inputted by the user.

Another objective of the present invention is to provide a user friendly computer assisted behavioral health assessment system to provide a method for medical personnel to track individual treatment compliance and monitor a specific user's results during treatment

Yet another objective of the present invention is to provide a user friendly computer assisted behavioral health assessment system to help identify parental concerns and address problematic behavior earlier, before it escalates, thereby accelerating parenting skills by providing additional intervention tools to parents and in doing so thereby decreasing the frequency and intensity of violent behavior in individual children and adolescents and improving children's lives by reducing the impact of traumatic experiences, while at the same time reducing the costs of long-term or intensive treatment and assisting medical personnel with additional information to help in making medical diagnosis.

Information relevant to attempts to address these objectives can be found in commercially available products sold under the product names: C.H.A.D.I.S. (Child Health and Development Interactive System), Teen Screen, and B-H Works. However, the foregoing reference suffers from one or more of the following disadvantages, the behavior health assessment system: was complicated to use, only confirmed expected diagnosis, relied on known assessment instruments, was intended to be used on a specific subsection of the population, was intended to identify a limited number of problems, was not a comprehensive evaluation tool of identified behaviors, or the system did not offer recommendations for treatment.

In light of the above, it would be beneficial to have a user friendly computer assisted behavioral health assessment system using proprietary algorithms to interpret and score user generated input to produce a substantially real-time preliminary evaluation of the subject's behavioral health vital signs including recommendations for treatment.

### SUMMARY OF THE INVENTION

The present invention is directed to the field of behavioral health assessment systems, specifically, a user friendly computer assisted behavioral health assessment systems using proprietary algorithms to interpret and score user generated input to produce a substantially real-time preliminary evaluation of a subject's behavioral health vital signs including recommendations for treatment.

One embodiment of the present invention can include a behavior health assessment system that includes a user friendly input computing device that is communicatively connected to a network of at least one other computing device capable of executing various applications including applications that require scoring, evaluating, and saving for later retrieval, modification or further evaluation, user inputted data using proprietary algorithms to generate a substantially real-time preliminary evaluation of a subject's behavioral health vital signs including recommendations for treatment.

The behavior health assessment system embodied in the present invention overcomes the shortcomings of the prior art's attempts to fulfill the void in the behavioral healthcare provider market by providing a behavior health assessment system that is an ongoing assessment that is administered at least annually for the early identification of behavioral problems and disorders.

The present invention offers treatment recommendations and methodology for monitoring identified behaviors; additionally, the present invention also ranks the severity of problems using a predetermined ranking criterion, it is a comprehensive behavioral health assessment that screens across all domains of a child and adolescent's life and it can be used for all age groups and it also allows for monitoring of the progress from recommended treatments, rather than an assessment for a narrow subset of conditions and age specific subjects.

The preliminary evaluation of the subject's behavioral health vital signs including recommendations for treatment are provided to the parent in substantially real-time thereby facilitating the parent's immediate implementation of the recommended treatment. The use of computing devices for scoring, evaluating, and saving for later retrieval, modification or further evaluation of user inputted data allows for the healthcare provider to easily track and monitor an individual's maturation and progress as they are being treated, in a convenient portable manner.

### BRIEF DESCRIPTION OF THE DRAWINGS

Presently preferred embodiments are shown in the drawings. It should be appreciated, however, that the invention is not limited to the precise arrangements and instrumentalities shown. Moreover, many aspects of the present disclosure can be better understood with reference to the following drawings. The components in the drawings are not necessarily to scale, emphasis instead being placed upon clearly illustrating the principles of the disclosure. In the following drawings, like reference numerals designate corresponding parts throughout the several views.

FIG. 1 is a flowchart illustrating an example of the process of a behavioral health assessment application according to various embodiments of the present disclosure.

FIG. 2 demonstrates a sample question that a parent answers according to various embodiments of the present disclosure;

FIG. 3A-E is a sample report format for a pediatrician according to various embodiments of the present disclosure;

FIG. 4A-D is a sample report format for a parent according to various embodiments of the present disclosure;

FIG. 5 is a flowchart of functionality of at least a portion of the behavioral health assessment application according to various embodiments of the present disclosure;

FIG. 6 is a graph showing Problem Identification-Severity according to various embodiments of the present disclosure.

FIG. 7 is a graph of Problem Clusters-Identification of Problems, Concerns, & Disorders according to various embodiments of the present disclosure.

FIG. 8 demonstrates an example of the formula for the Problem Severity algorithm according to various embodiments of the present disclosure.

FIG. 9 is a flowchart of an example of the process of how the behavioral health assessment application determines Problem Clusters according to various embodiments of the present disclosure.

FIG. 10 is an example of the behavioral health assessment application implemented in a networked environment according to various embodiments of the present disclosure.

FIG. 11 is a schematic block diagram of an example of at least a portion of the networked environment of FIG. 10 according to various embodiments of the present disclosure.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

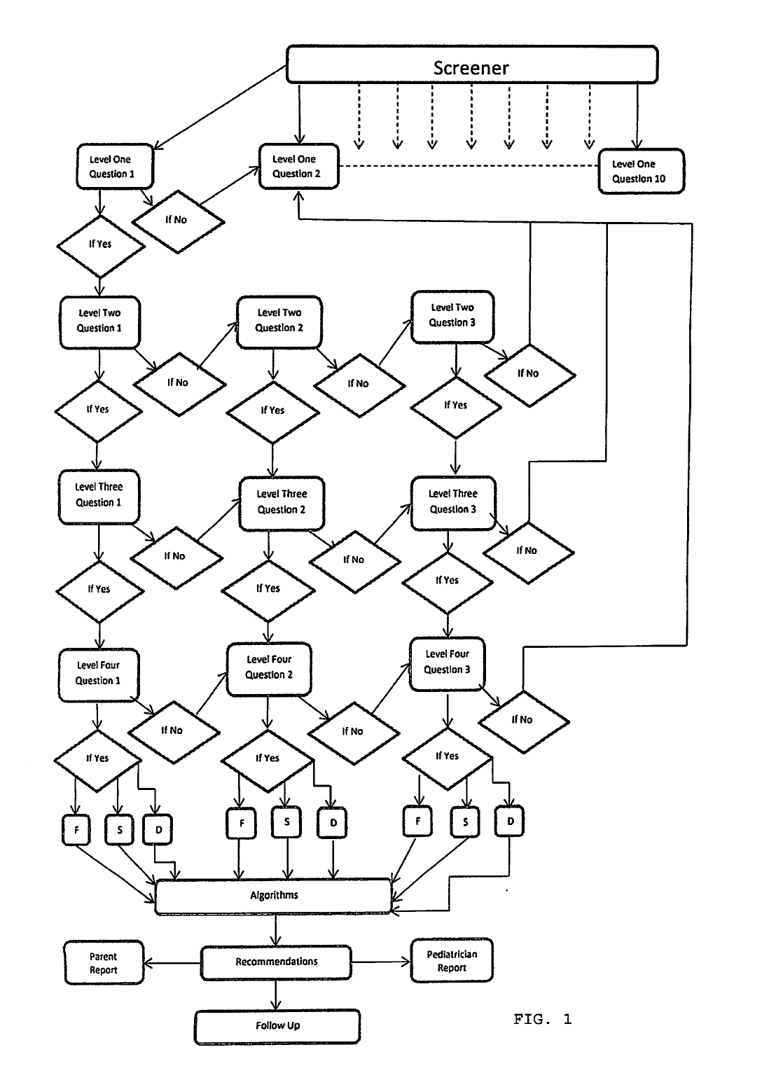

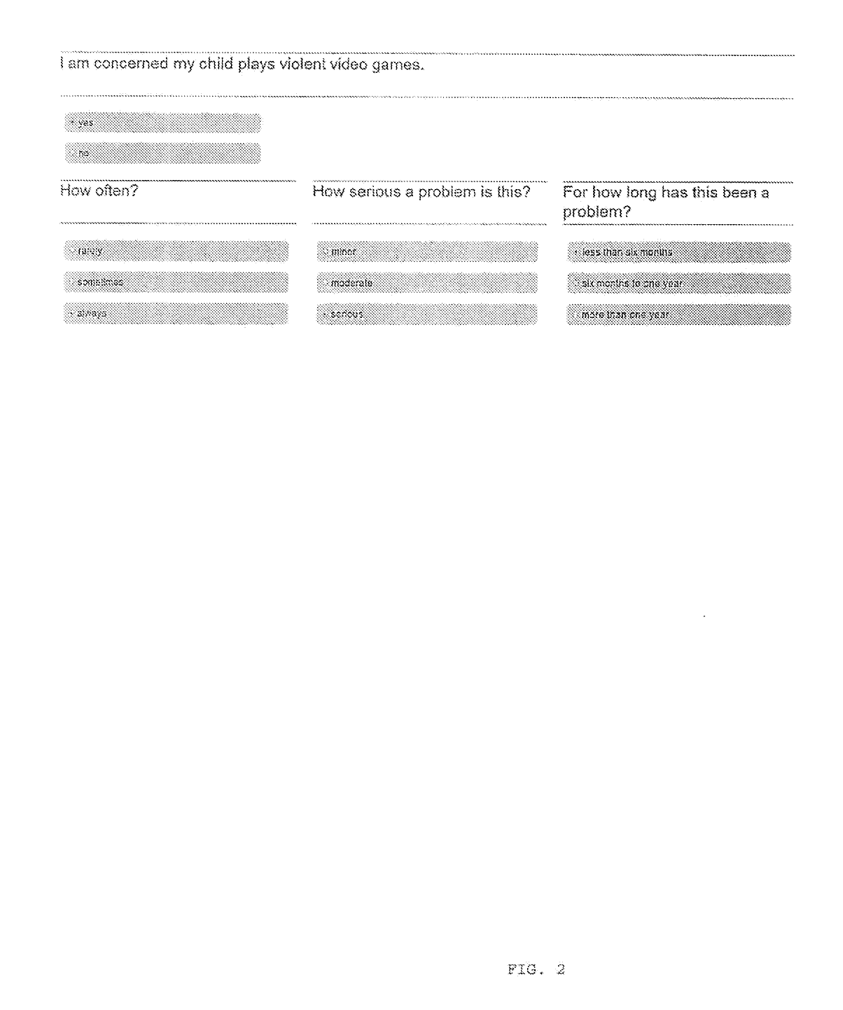

For purposes of this description, the terms “upper,” “bottom,” “right,” “left,” “front,” “vertical,” “horizontal,” and derivatives thereof shall relate to the invention as oriented in FIGS. 1-10.

The present invention is directed to the field of behavioral health assessment systems, specifically, a user friendly computer assisted behavioral health assessment systems using proprietary algorithms to interpret and score user generated input to produce a substantially real-time preliminary evaluation of a subject's behavioral health vital signs including recommendations for treatment, wherein said recommendations might include evidenced based recommendations based on the severity of the problems, that are commonly used by practitioners in the behavioral health field.

The user friendly computer assisted behavioral health assessment system 10 of the present invention will be described in considerable detail below; however, an initial overview may be helpful to provide a framework of reference for the more detailed discussion that will follow.

Various embodiments of the present invention provide for a cloud-based, or otherwise remotely stored internet based computing system including a behavioral health assessment application accessible remotely using wireless data exchanging communication protocols. The behavioral health assessment application may be accessed over the Internet at home or on tablet computers in the pediatrician's office. Prior to seeing the healthcare provider, parents are asked to complete an initial assessment that compiles a particular child's behavioral health issues and establishes a baseline measuring point for the particular child's behaviors.

Parents rate the frequency, duration, and severity of their child's behaviors and this data is scored and evaluated using proprietary algorithms to identify the severity of these behaviors as either: none, minor, moderate, or serious. Proprietary algorithms are used to evaluate and assign ratings for each question to determine the severity of a particular behavioral problem.

Proprietary algorithm metrics adds the following metrics: age, gender, frequency, severity, and chronicity as selected by the parent to score an individual question. It is contemplated that one embodiment of the present invention might use the following formula to determine the severity of a particular behavioral problem. It is also contemplated that alternative metrics may be used.

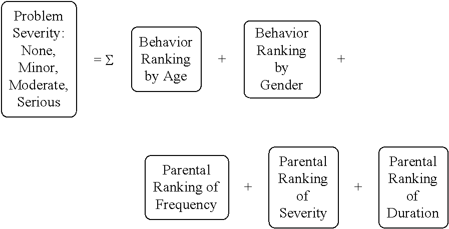

Although it is stated above that the metrics are added, it is envisioned that alternative embodiments may include algorithms that add, subtract, divide, and/or multiply and all combinations thereof with respect to a specific evaluative metric.

This information is stored for later retrieval, modification or further evaluation on a remotely accessible data server. The healthcare provider is given an immediate report that identifies moderate and severe problem behaviors, as well as other behavioral health vital signs. Suggested recommendations are also provided for the healthcare provider to review with the parent. A report is generated for the medical file, and a second report that includes recommendations and other resources, is given to the parent. At subsequent visits, follow-up screenings are conducted to track progress and to identify new problems, if any. The information is then updated accordingly.

FIG. 1 is a flowchart of the process of how a behavioral health assessment application may be used. FIG. 1 shows the flow of the decision making process that parents encounter as they complete the protocol. They are presented with first level questions to which they answer “yes” or “no.” If they answer “no,” they proceed to the next first level question. If they answer “yes,” they proceed to a series of second level questions, where they again choose “yes” or “no.” For each “yes,” there may be a third or even a fourth level question to which they select “yes” or “no.” If they answer “yes,” they will also be asked to rank the item according to frequency, duration, and severity. In this manner they will answer all questions within a section, wherein the questions are organized as levels or tiers that are hierarchically arranged in terms of severity. At the completion of the section, these responses will be scored and evaluated using proprietary algorithms, defined by category and clusters. Based on the evaluation of the user inputted data using proprietary algorithms, recommendations regarding treatment will be identified and provided in reports that are given to the healthcare provider and parents. This data is stored in a remotely accessible data server for future retrieval, modification and further evaluation. It is envisioned that all children would be evaluated annually.

In operation, the parent would answer a minimum of eleven questions that would cover every major area of parental concern. If a parent selects yes to a major question, they would be asked a series of relevant questions to more clearly define and identify how serious a problem the child/adolescent has in this area. It is envisioned that the questions presented to the user would fall into a plurality of different categories, by way of example, but not to be limiting in any recognizable manner, categories such as: At-Home, Habits, School Related, Family Related, Peer Related, Authority Related, Addictions, Emotional, Trauma, Environmental Situations, Coping. After completing the entire questionnaire, the application would evaluate the user inputted data provided by the parent using proprietary algorithms. The application would also provide data for medical diagnosis within the healthcare provider's report cluster items.

Turning to FIG. 2, shown is an example of a sample question that a user/parent/caregiver would complete. For example, the behavioral health assessment application may present a question to a user/parent/caregiver. In various embodiments, questions are selected from a question bank and then presented to a user/parent/caregiver. It is envisioned that the questions presented to the user would fall into a plurality of different categories, by way of example, but not to be limiting in any recognizable manner, categories such as: At-Home, Habits, School Related, Family Related, Peer Related, Authority Related, Addictions, Emotional, Trauma, Environmental Situations, Coping.

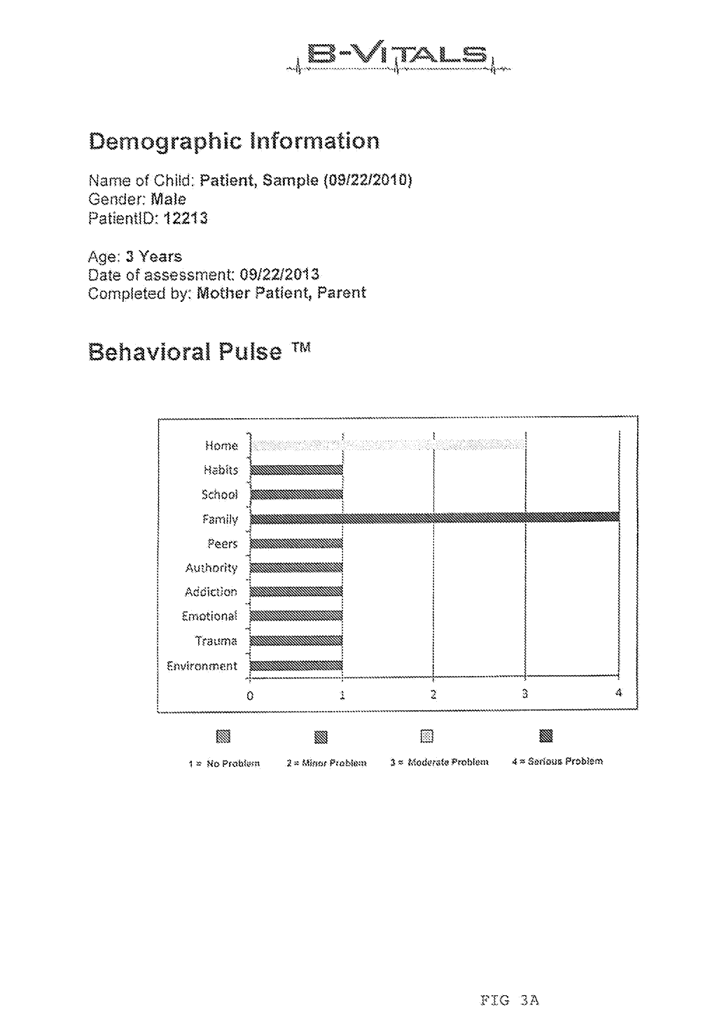

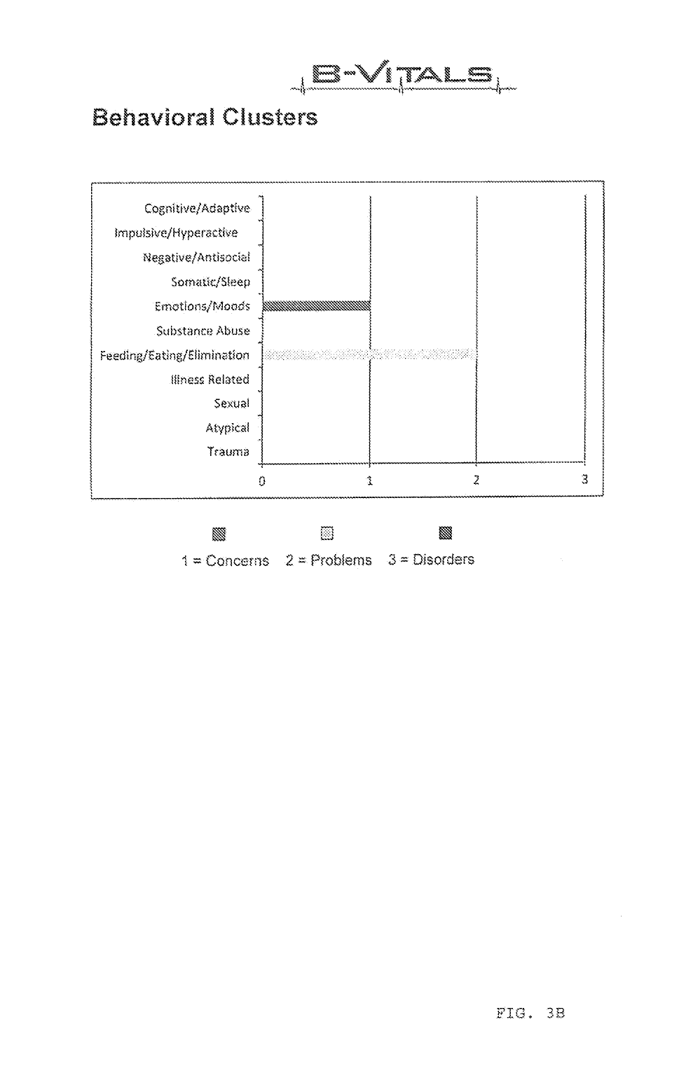

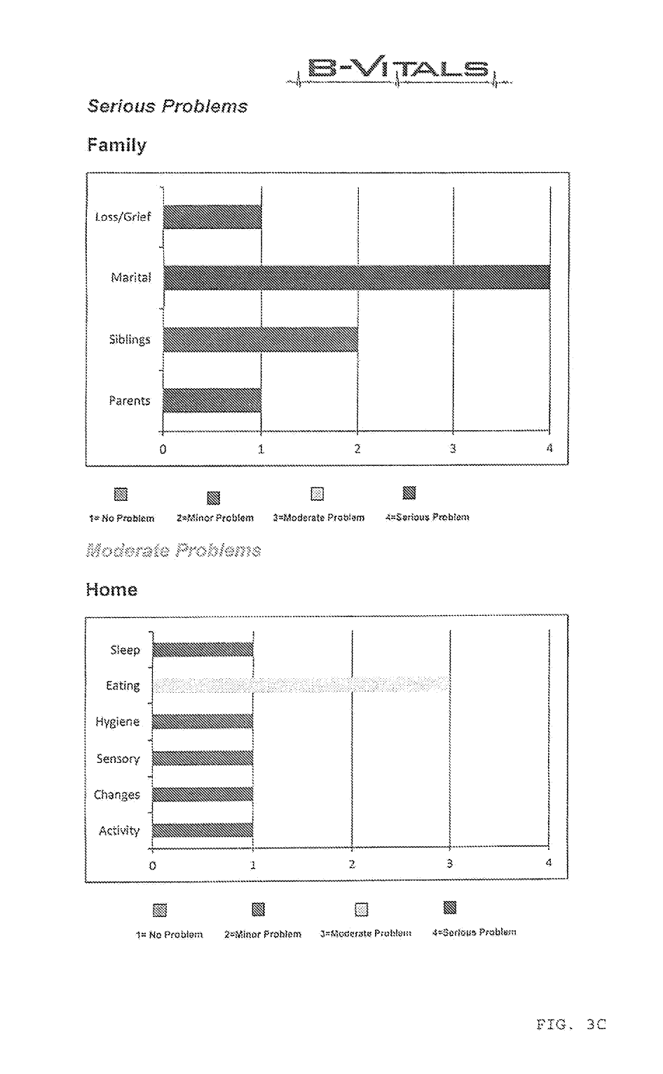

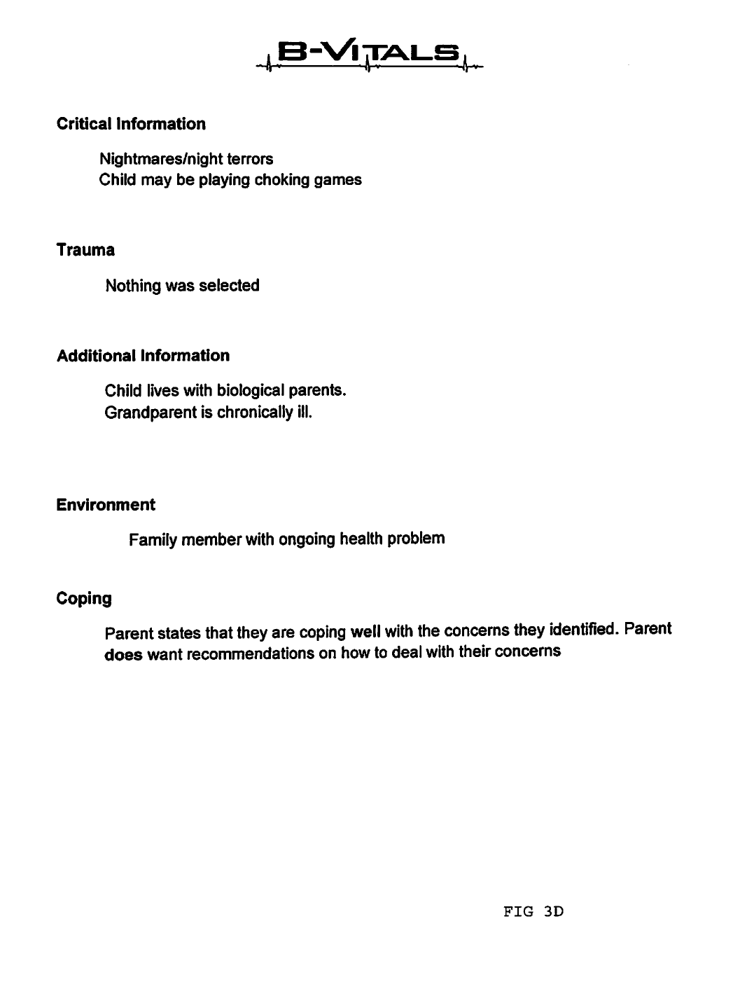

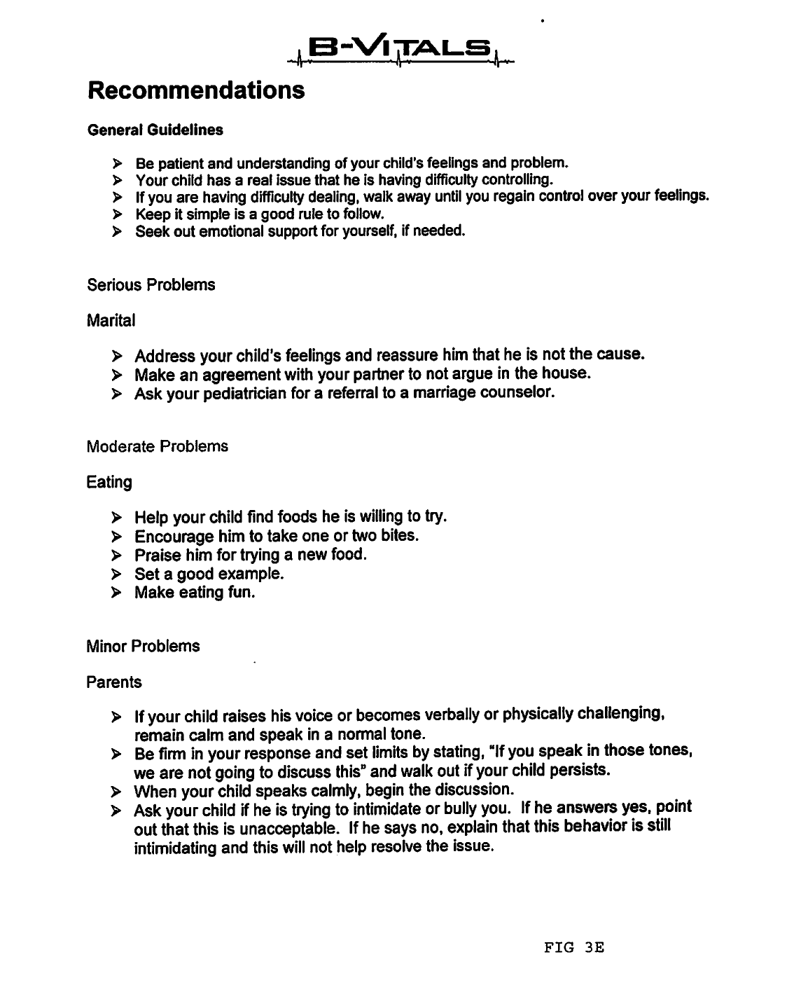

Referring next, FIG. 3, shown is a sample report format for a healthcare provider. The report for a health care provider includes graphs of Problem Severity and Problem Clusters, a list of critical information, and recommendations that are provided to the parent. It is envisioned that the list of critical information includes those important items that identify more serious behavioral events than are typically seen. Some examples include, but are not limited to: suicide attempts, nightmares, being bullied, collecting weapons, night terrors, hurting others on purpose, starting fires, etc.

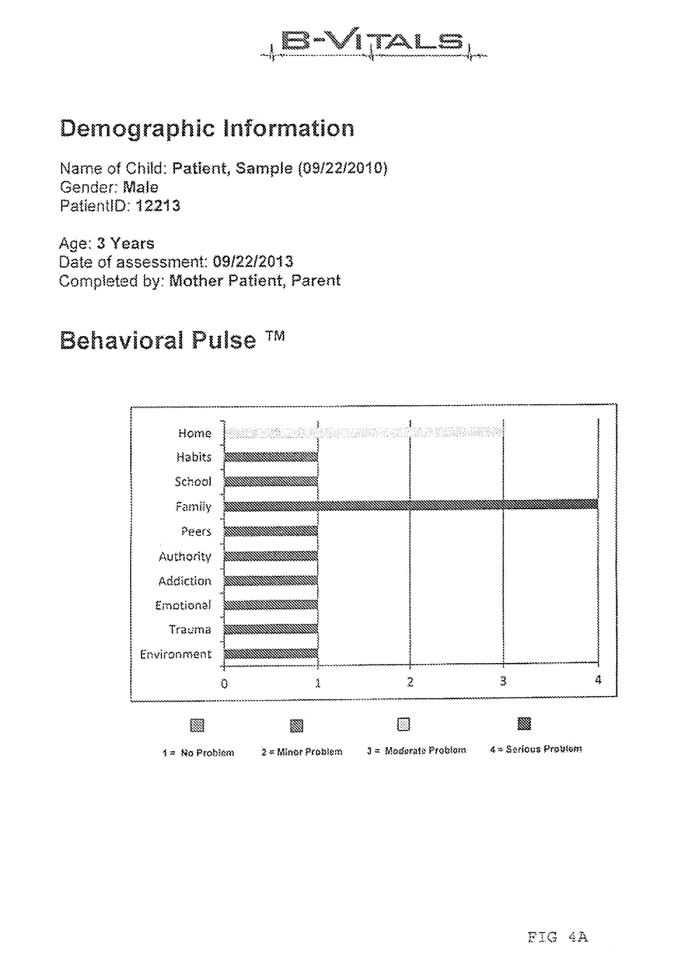

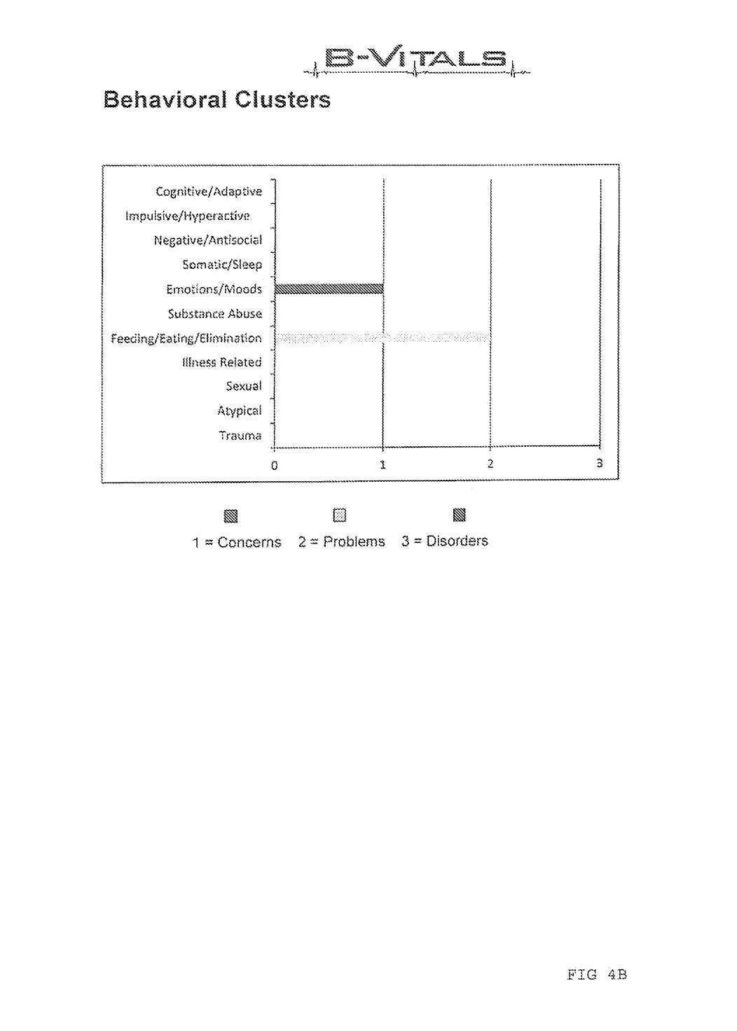

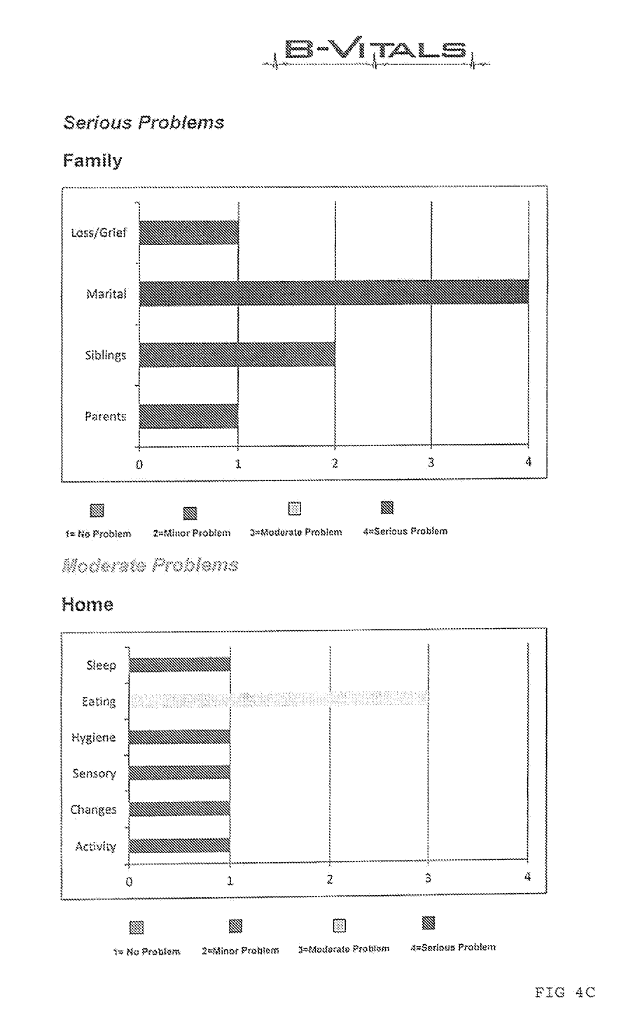

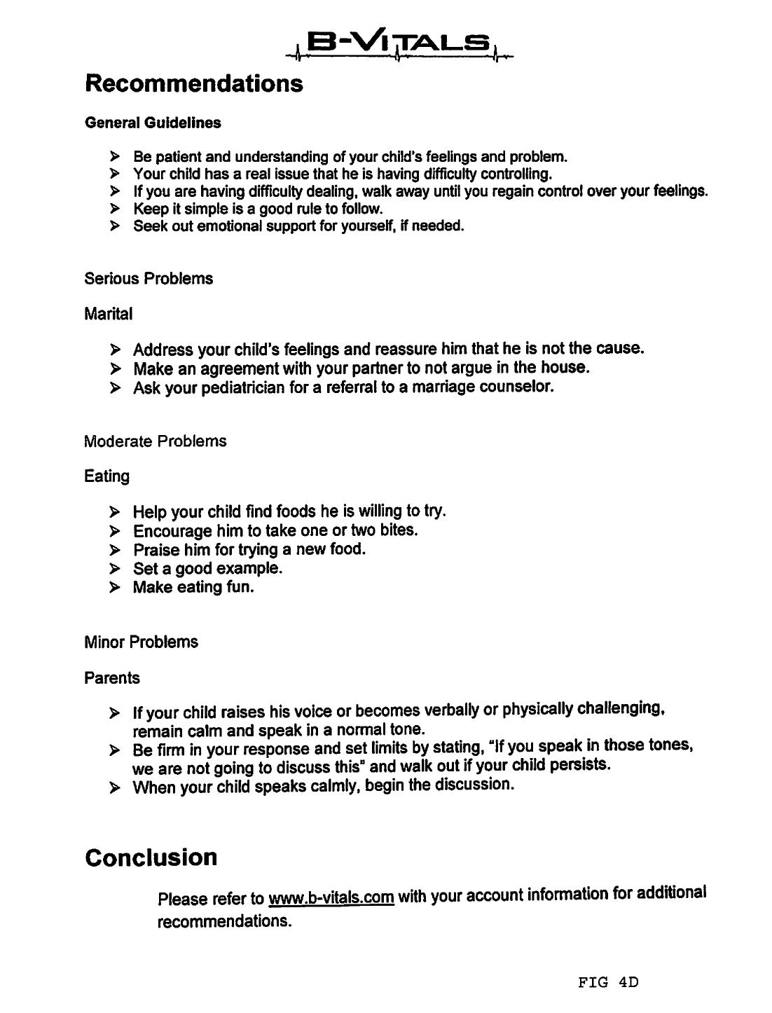

Moving to FIG. 4, shown is a sample report format for a parent. The report for a parent includes a graph of Problem Severity and recommendations for addressing the parental concerns for their child.

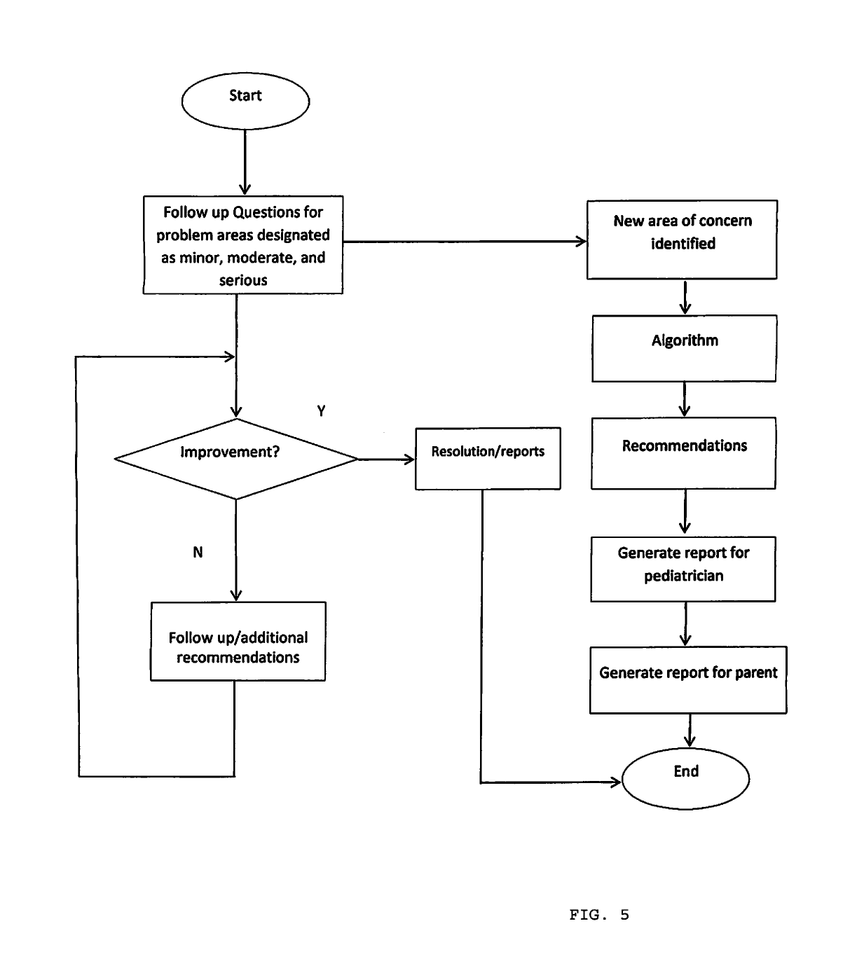

Next, with respect to FIG. 5, shown is a flowchart of the process demonstrating how one of the features of the behavioral health assessment application may be used. FIG. 5 provides a non-limiting example of a follow-up process of the behavioral health assessment application. The follow-up process provides a parent with the initially identified problem areas of the child and asks the user to identify any progress that has been made, and whether there are any new concerns regarding this or other issues. Recommendations are offered for any newly identified problems. Additional recommendations for the previously identified problems are offered based upon the feedback provided by the parent. This information is included in a new Parent and Healthcare provider Report. It is envisioned that follow-up process would be used during subsequent visits to the healthcare provider a means to monitor progress, track compliance as well as identify potential new areas of parental concern.

The evaluative metrics and formula used in evaluating the user inputted data to analyze the data obtained during the follow-up process are the same evaluative metrics and formulas used in the cluster algorithm metrics analysis discussed herein. It is envisioned that alternative embodiments may include algorithms that add, subtract, divide, and/or multiply and all combinations thereof with respect to a specific evaluative metric.

Turning now to FIG. 6, shown is a graph of Problem Severity. This graph includes the identified areas measured with a graphic demonstration of the degree of severity of each problem area.

Now referring to FIG. 7, shown is a graph of Behavioral Clusters. The non-limiting example of FIG. 7 includes the Behavioral Clusters with a graphic demonstration of whether this Cluster is a parental Concern, a Problem, or a Disorder.

It is envisioned that the clusters would fall into a plurality of different categories, by way of example, but not to be limiting in any recognizable manner, categories such as: Cognitive-Adaptive, Impulsive-Hyper, Negative Anti-Social, Substance Abuse, Emotions/Moods, Somatic Sleep, Feeding/Eating/Elimination, Illness, Sex, Atypical, and Trauma.

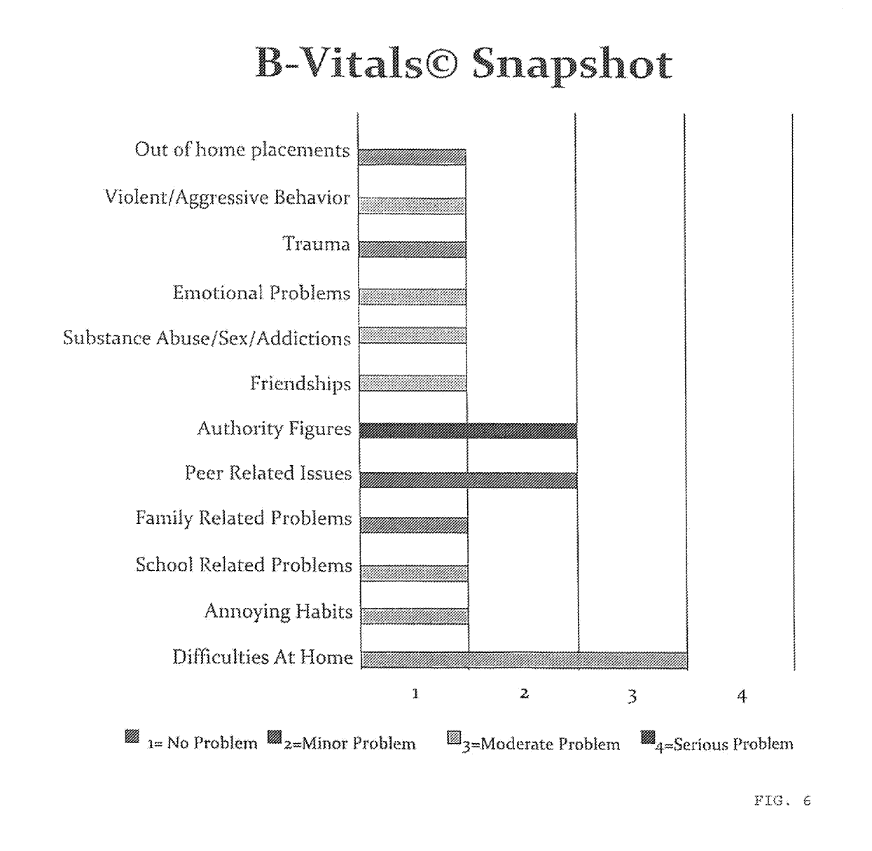

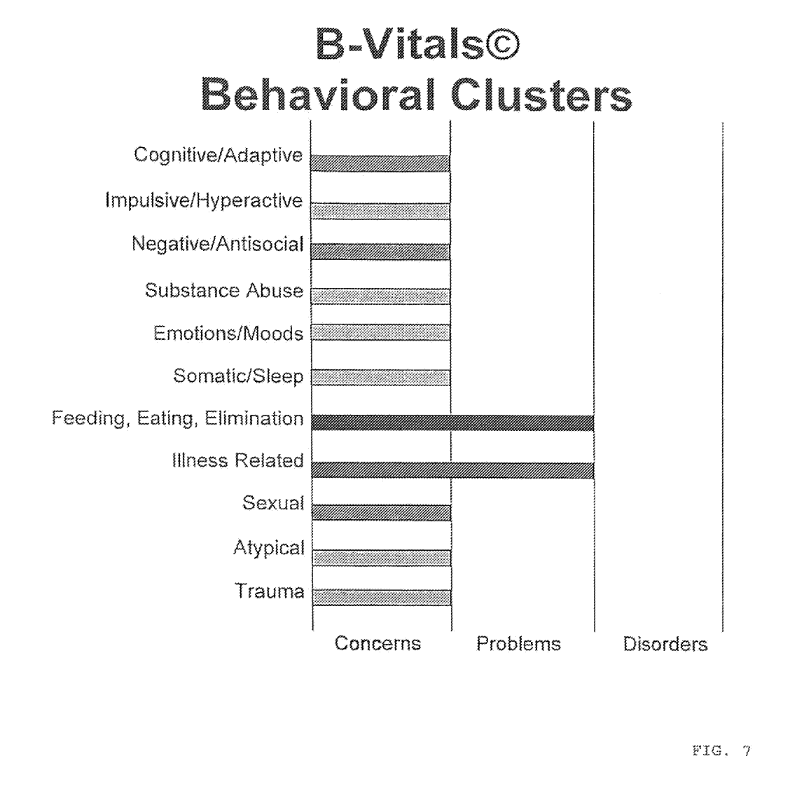

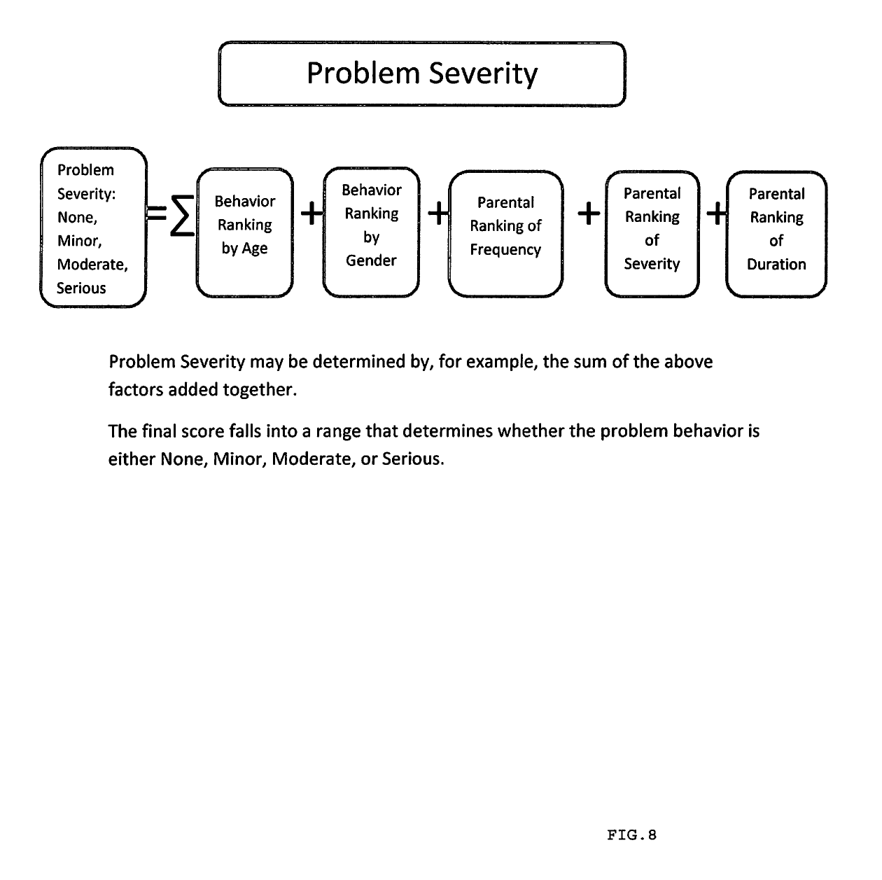

Moving to FIG. 8, shown is a graph of the Problem Severity Algorithm. Through the use of this exemplary formula, the seriousness of a behavior problem can be identified as none, minor, moderate, or serious.

Next, FIG. 9 is a flowchart of the process of how the behavioral health assessment application determines Problem Clusters.

To summarize, the behavioral health assessment application is completed by a user/parent/caregiver. Based on responses of the user/parent/caregiver, questions become more specific through a decision tree process. The frequency and severity of problems are reported by the user/parent/caregiver. Based upon these responses, specific problem areas are identified and ranked as to seriousness. Suggested recommendations are then provided for the healthcare provider to provide to the parent for amelioration of these problems. Monitoring of these interventions occurs at follow-up visits.

The behavioral health assessment application provides a multi-level comprehensive assessment of behavioral health of a child or adolescent for the immediate use by the healthcare provider. The behavioral health assessment application ranks behavioral health problem severity as none, minor, moderate, or serious as reported by a user/parent/caregiver. In various embodiments, the severity of a behavioral problem is identified according to the following factors: age, gender, parental perception of frequency, parental perception of duration, and parental perception of severity. To this end, the behavioral health assessment application may assist a healthcare provider to discern differences between whether an identified issue is a parental concern, a behavioral problem, or a disorder that requires intervention based on a system using proprietary algorithms to interpret and score user generated input to produce a substantially real-time preliminary evaluation of the subject's behavioral health vital signs including recommendations for treatment.

The behavioral health assessment application may utilize a Cluster algorithm or procedure to identify problem clusters according to the following factors: situational chronicity, test items within a cluster, frequency of behaviors, severity of behaviors, and critical items. Cluster algorithms are the formula developed to separate the parental concern from a problem behavior and a diagnosable condition based on DSM-5 criteria. Cluster algorithms are based on the categories of the DSM-PC across all questions.

It is contemplated that one embodiment of the present invention might use the following formula to identify the problem clusters. It is also contemplated that alternative metrics and calculations may be used as well.

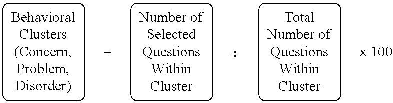

Cluster algorithm metrics adds the DSM-PC criteria plus one additional category. Cluster algorithm metrics adds the number of answered questions by the parent and the total is divided by the number of questions for that section. All sections are added for the cluster. The resultant score is determined by the ranges and ranked as Concerns, Problems, or Disorders. Critical items increase the score upward by one category. It is also envisioned that alternative embodiments may include algorithms that add, subtract, divide, and/or multiply and all combinations thereof with respect to a specific evaluative metric.

Recommendations may be made according to mild, moderate, and severe behavior classifications. Recommendations may be generated for parental intervention to modify identified problem behaviors.

Additionally, healthcare providers may monitor changes in identified behavioral problems as to whether they improve, remain the same, or become worse based on parental responses.

Various embodiments of the present invention are directed to and focused on “at-risk” behaviors, such as, for example, including but not limited to, ADHD (Attention Deficit Hyperactive Disorder), physical, verbal, emotional, and sexual violence, depression and anxiety, bullying, cutting and self-mutilation, eating disorders, tics, school related behavior problems, obsessive/compulsive behaviors, substance abuse and addictive behaviors, trauma, etc.

The behavioral health assessment application may employ a follow-up procedure for allowing healthcare providers to monitor and track compliance with follow-up evaluations and/or assessments.

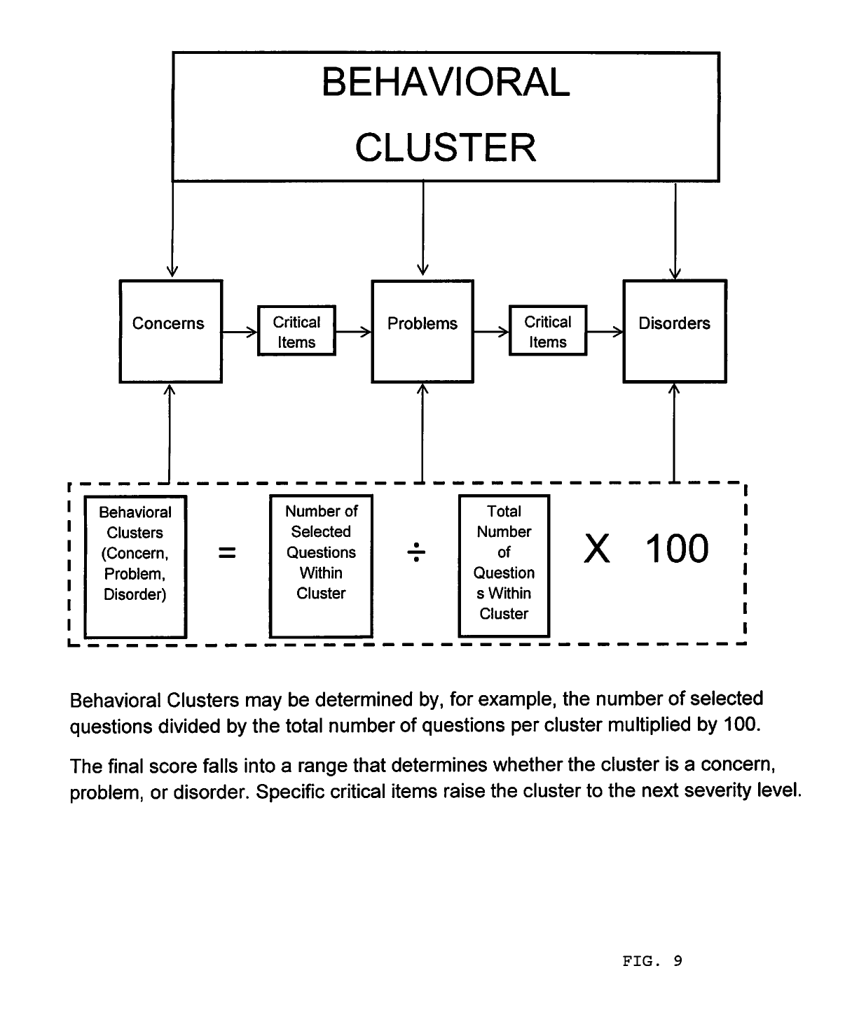

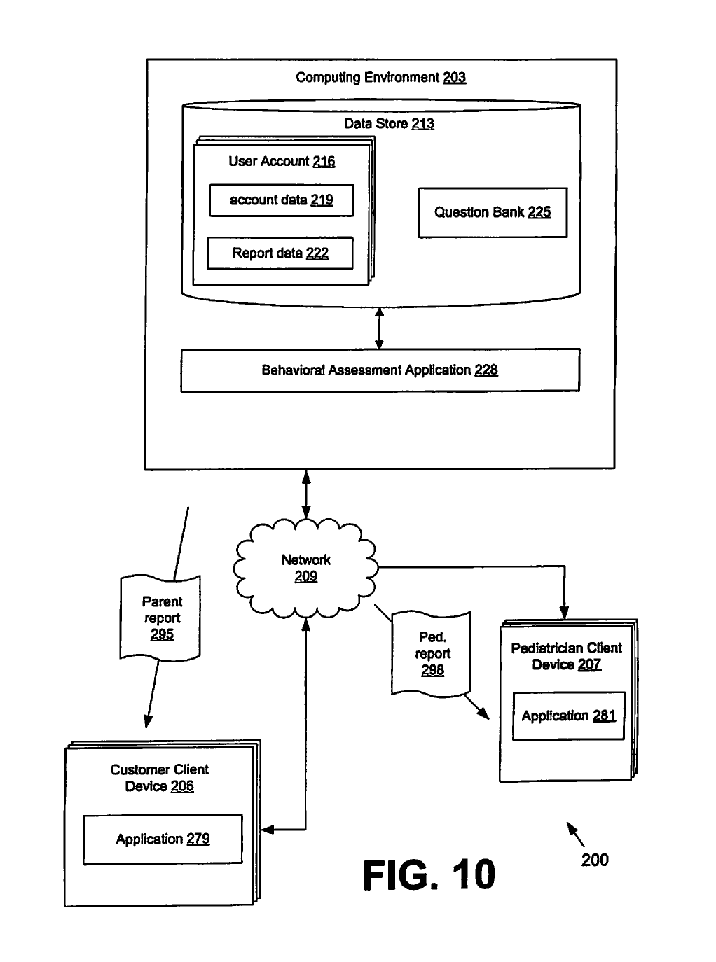

With reference to FIG. 10, shown is a networked environment 200 according to various embodiments. The networked environment 200 may include a computing environment 203, one or more client devices 206, 207, and possibly other devices in data communication through a network 209. The network 209 may include, for example, the Internet, intranets, extranets; wide area networks (WANs), local area networks (LANs), wired networks, wireless networks, any other suitable networks, or any combination thereof.

The computing environment 203 may comprise, for example, a server computer or any other system providing computing capability. Alternatively, a plurality of computing devices may be employed that are arranged, for example, in one or more server banks, computer banks, or other arrangements. For example, computing environment may comprise a cloud computing resource, a grid computing resource, and/or any other distributed computing arrangement. Such computing devices may be located in a single installation or may be distributed among many different geographical locations.

Various applications and/or other functionality may be executed in the computing environment 203 according to various embodiments. Also, various data may be stored in a data store 213 that is accessible to the computing environment 203. The data store 213 may be representative of a plurality of data stores. The data stored in the data store 213, for example, may be associated with the operation of the various applications and/or functional entities to be described later.

For instance, the data store 213 may include data representing one or more user accounts 241, or any other data used to facilitate the operation of various applications and/or functional entities executed in connection with the computing environment 203. Each user account 241 may be maintained for the benefit of a particular user such as a child or young adult. Furthermore, the user account 241 may be managed by one or more parents or caregiver responsible for the child/young adult. Each user account 241 may include account data 219 for managing the user account 216. The account data 219 may comprise user information, personal information, security information, password data, or any other data related to the user account 216. The user account 216 may also comprise report data 222 for storing responses to questions. The report data 222 may include any previous reports or statistical models that quantify a behavioral health assessment. The data store 213 may also comprise a question bank that stores a plurality of questions for facilitating behavioral health assessment.

The components executed in the computing environment 203 include, for example, a behavioral health assessment application 228, and possibly other applications, services, processes, systems, engines, or functionality not discussed in detail herein. The behavioral health assessment application 228 may be configured to encode one or more user interfaces for display to a user such as a parent, caregiver, and/or healthcare provider. To this end, the behavioral health assessment application 228 may generate a network site or portal to provide the services of behavioral health assessment application 228 to various users. The network site may encode for display network content embodied in some other form that facilitates access to the services offered by the behavioral health assessment application 228. The network site or portal may include a network page server to serve data such as the network pages to users operating devices such as “smart phones”, personal computers, tablet computing devices, or other similar devices known or reasonably should be known to exist in the art. Network pages comprising user interfaces may be served to client devices 206, 207, over a protocol such as hypertext transfer protocol (HTTP), simple object access protocol (SOAP), and/or other protocols. Such a network page server may comprise a commercially available network page server such as, for example, Apache® HTTP Server, Microsoft® Internet Information Services (IIS), and/or other network page servers.

The client devices 206, 207 are representative of a plurality of client devices that may be coupled to the network 209. The client device 206, 207 may comprise, for example, a processor-based system such as a personal computing device. Such a personal computing device may be embodied in the form of a desktop computer, a laptop computer, a personal digital assistant, a cellular telephone, a set-top box, a web pad, a tablet computer system, or other device with like capability.

The client device may be a customer client device 206 used by a user/parent/caregiver. The customer client device 206 may be configured to execute various applications, such as a dedicated application 279 to access and render network pages, such as web pages, or other network content served up by the computing environment 203 and/or other servers. The application 279 may be a browser that provides a user interface to facilitate interaction with the browser and the client device 206. The customer client device 206 may be configured to receive a parent report 295 in response to answering questions prompted by the behavioral health assessment application 228. For example, the report may be the sample report as seen in the non-limiting example of FIG. 4.

The client device may be a pediatrician client device 207 used by a pediatrician. The pediatrician client device 207 may be configured to execute various applications, such as a dedicated application 281 to access and render network pages, such as web pages, or other network content served up by the computing environment 203 and/or other servers. The application 281 may be a browser that provides a user interface to facilitate interaction with the browser and the client device 207. The pediatrician client device 207 may be configured to receive a pediatrician report 298 such as the sample report of the non-limiting example of FIG. 3.

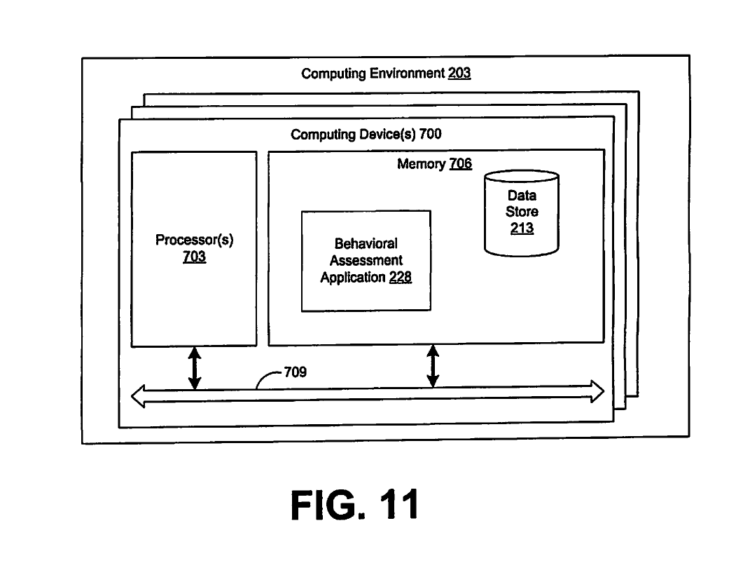

With reference to FIG. 11, shown is a schematic block diagram of the computing environment 203 according to an embodiment of the present invention. The computing environment 203 includes one or more computing devices 700. The computing device 700 includes at least one processor circuit, for example, having a processor 703 and a memory 706, both of which are coupled to a local interface 709. To this end, the computing device 700 may comprise, for example, at least one server computer or like device. The local interface 709 may comprise, for example, a data bus with an accompanying address/control bus or other bus structure as can be appreciated.

Stored in the memory 706 are both data and several components that are executable by the processor 703. In particular, stored in the memory 706 and executable by the processor 703 is the behavioral health assessment application 228, and potentially other applications. Also stored in the memory 706 may be the data store 213 and other data.

Those skilled in the art would quickly realize that it is understood that there may be other applications that are stored in the memory 706 and are executable by the processors 703. Where any component discussed herein is implemented in the form of software, any one of a number of programming languages may be employed such as, for example, C, C++, C#, Objective C, Java, JavaScript, Perl, PHP, Visual Basic, Python, Ruby, Delphi, Flash, or other programming languages.

A number of software components are stored in the memory 706 and are executable by the processor 703. In this respect, the term “executable” means a program file that is in a form that can ultimately be run by the processor 703. Examples of executable programs may be, for example, a compiled program that can be translated into machine code in a format that can be loaded into a random access portion of the memory 706 and run by the processor 703, source code that may be expressed in proper format such as object code that is capable of being loaded into a random access portion of the memory 706 and executed by the processor 703, or source code that may be interpreted by another executable program to generate instructions in a random access portion of the memory 706 to be executed by the processor 703, etc. An executable program may be stored in any portion or component of the memory 706 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 706 is defined herein as including both volatile and nonvolatile memory and data storage components. Volatile components are those that do not retain data values upon loss of power. Nonvolatile components are those that retain data upon a loss of power. Thus, the memory 706 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 703 may represent multiple processors 703 and the memory 706 may represent multiple memories 706 that operate in parallel processing circuits, respectively. In such a case, the local interface 709 may be an appropriate network 209 (FIG. 2) that facilitates communication between any two of the multiple processors 703, between any processor 703 and any of the memories 706, or between any two of the memories 706, etc. The local interface 709 may comprise additional systems designed to coordinate this communication, including, for example, performing load balancing. The processor 703 may be of electrical or of some other available construction.

Although the behavioral health assessment application 228, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts discussed in the present disclosure show the functionality and operation of an implementation of portions of at least the behavioral health assessment application 228. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 703 in a computer system or other system. The machine code may be converted from the source code, etc. If embodied in hardware, each block may represent a circuit or a number of interconnected circuits to implement the specified logical function(s).

Although the flowcharts of the present disclosure show a specific order of execution, it is understood that the order of execution may differ from that which is depicted. For example, the order of execution of two or more blocks may be scrambled relative to the order shown. Also, two or more blocks shown in succession in the flowcharts may be executed concurrently or with partial concurrence. Further, in some embodiments, one or more of the blocks shown in the flow charts may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such combinations and variations thereof are within the scope of the present disclosure.

Also, any logic or application described herein, including the behavioral health assessment application 228, that comprises software or code can be embodied in any non-transitory computer-readable medium for use by or in connection with an instruction execution system such as, for example, a processor 703 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A user friendly computer assisted behavioral health assessment systems using proprietary algorithms to interpret and score user generated input to produce a substantially real-time preliminary evaluation of a subject's behavioral health vital signs including recommendations for treatment, said system comprising:
a server connected to a communications network;
a first computing device connected to the server on which software is stored for access by a third party user;
at least a second computing device communicatively connected to the server via the communications network further comprising a display screen and a user interface for interactive use by the user, including access to the software stored on the first computing device to input user generated data; and
software installed on the server to interpret and score user generated input to produce a substantially real-time preliminary evaluation of the subject's behavioral health vital signs including recommendations for treatment.

2. The system of claim 1, wherein the at least second computing device comprises a touchscreen portable tablet computing device and the communications network comprises the Internet, and the software is accessible and viewable for interactive use on a website stored on the server and viewable on the touchscreen portable tablet.

3. The system of claim 1, wherein the software comprises executable programs using proprietary algorithms to assign ratings for each question to determine severity of a particular behavioral problem, wherein the proprietary algorithms metrics adds the following metrics: age, gender, frequency, severity, and chronicity as selected by the user to score an individual question.

4. The system of claim 1, wherein the software comprises cluster algorithms for categorizing behavioral data, wherein the cluster algorithm metrics adds the DSM-PC criteria plus one additional category, moreover, the cluster algorithm metrics add the number of answered questions by the user and the total is then divided by the number of questions for that section, all sections are added for the cluster such that the resultant cumulative raw score, although it is possible that a raw score may be enhanced by a predetermined factor triggered by a predetermined occurrence.

5. The system of claim 1, wherein the software comprises of a question module wherein the questions presented to the user fall into a plurality of different categories such as: At-Home, Habits, School Related, Family Related, Peer Related, Authority Related, Addictions, Emotional, Trauma, Environmental Situations, and Coping.

6. The system of claim 1, wherein the substantially real-time preliminary evaluation of the subject's behavioral health vital signs including recommendations for treatment includes a report for a healthcare provider, said report includes graphs of Problem Severity and Problem Clusters, a list of critical information, and recommendations that are provided to the parent, wherein said list of critical information comprises those important items that identify more serious behavioral events than are typically seen, including: suicide attempts, nightmares, being bullied, collecting weapons, night terrors, hurting others on purpose, and starting fires.

7. The system of claim 1, further comprising a follow up process module, wherein said follow up process module further comprises of providing a user with the initially identified problem areas of the child and asking the user to identify any progress has been made, and whether there are any new concerns regarding this or other issues, wherein said follow up process module further comprises of recommendations that are offered for any newly identified problems as well as additional recommendations for the previously identified problems, wherein said recommendations are offered based upon the feedback provided by the user.

8. The system of claim 1, wherein the software comprises executable programs using proprietary algorithms to assign ratings for each question to determine the severity of a particular behavioral problem, wherein the proprietary algorithms compare and evaluate behavior clusters that fall into a plurality of different categories such as: Cognitive-Adaptive, Impulsive-Hyper, Negative Anti-Social, Substance Abuse, Emotions/Moods, Somatic Sleep, Feeding/Eating/Elimination, Illness, Sex, Atypical, and Trauma.

9. The system of claim 1, wherein the software comprises executable programs using proprietary algorithms to assign ratings for each question to determine the severity of a particular behavioral problem, wherein the proprietary algorithms compare and evaluate behavior problems such that the seriousness of the behavior problem can be identified as non, mild, moderate, or severe, based on a predetermined evaluative criteria.

10. The system of claim 1, wherein the software comprises executable programs using proprietary algorithms to assign ratings for each question to determine the severity of a particular behavioral problem, wherein the proprietary algorithms compare and evaluate “at risk” behaviors such as ADHD (Attention Deficit Hyperactive Disorder), physical, verbal, emotional, and sexual violence, depression and anxiety, bullying, cutting and self-mutilation, eating disorders, tics, school related behavior problems, obsessive/compulsive behaviors, substance abuse and addictive behaviors and trauma.

11. A method for evaluating and assessing the behavioral health of an individual using proprietary algorithms to interpret and score user generated input to produce a substantially real-time preliminary evaluation of a subject's behavioral health vital signs including recommendations for treatment, said method comprising:
providing a user with a user friendly computer assisted behavioral health assessment system comprising of
a server connected to a communications network;
a first computing device connected to the server on which software is stored for access by a third party user;
at least a second computing device communicatively connected to the server via the communications network further comprising a display screen and a user interface for interactive use by the user, including access to the software stored on the first computing device to input user generated data; and
software installed on the server to interpret and score user generated input to produce a substantially real-time preliminary evaluation of a subject's behavioral health vital signs including recommendations for treatment;
receiving user generated input in response to questions presented to the user regarding an individual's behavior to determine the severity of a particular behavioral problem, wherein the questions presented relate to the individual's age, gender, frequency of the specific behavior problem, severity of the specific behavior problem, and chronicity of the specific behavior problem;
evaluating the user generated input using proprietary algorithms and cluster algorithms to determine recommendations for treatment; and
providing the user with a substantially real time preliminary evaluation of the subject's behavioral health vital signs including recommendations for treatment including a report for a healthcare provider, said report including graphs of Problem Severity and Problem Clusters, a list of critical information, and recommendations that are provided to the parent, wherein said list of critical information comprises those important items that identify more serious behavioral events than are typically seen, including: suicide attempts, nightmares, being bullied, collecting weapons, night terrors, hurting others on purpose, and starting fires.

12. The method of claim 11, further comprising a follow up process module, wherein said follow up process module further comprises of providing a user with the initially identified problem areas of the child and asking the user to identify any progress has been made, and whether there are any new concerns regarding this or other issues, wherein said follow up process module further comprises of recommendations that are offered for any newly identified problems as well as additional recommendations for the previously identified problems, wherein said recommendations are offered based upon the feedback provided by the user.
